(19) United States
(12) Patent Application Publication
(10) Pub. No.: US 2017/0178466 A1
(43) Pub. Date: Jun. 22, 2017

(54) SYSTEM OF DISPLAYING USAGES OF HOME APPLIANCES BASED ON USER'S POSITION AND METHOD THEREOF

(71) Applicants: Inventec (Pudong) Technology Corporation, Shanghai (CN); Inventec (Beijing) Electronics Technology Co., Ltd, Beijing (CN)

(72) Inventor: CHAUCER CHIU, Taipei (TW)

(21) Appl. No.: 15/088,754

(22) Filed: Apr. 1, 2016

(30) Foreign Application Priority Data
Dec. 18, 2015 (CN) 201510961137.8

(51) Int. Cl. G08B 5/22; G08B 23/00

(52) U.S. Cl. CPC G08B 5/222; G08B 23/00

(57) ABSTRACT

The present disclosure illustrates a system for displaying usages of home appliances based on a user's position and a method thereof. In the system, after positions of home appliances are determined and usages of the home appliances are collected, a user's current position is determined based on the usages and positions of the home appliances, and based on the user's current position one of the home appliances is controlled to display usages of all home appliances. Therefore, the system and method of the present disclosure provides the user to check each of the home appliances without spending extra time, so as to achieve the technical effect of confirming whether all home appliances are in normal functioning anywhere and anytime.

### CROSS-REFERENCE TO RELATED APPLICATION

This application claims the benefit of Chinese Patent Application No. 201510961137.8, filed Dec. 18, 2015.

### BACKGROUND OF THE INVENTION

1. Field of the Invention

The present disclosure relates to a system of displaying usages of home appliances and a method thereof, more particularly to a system of displaying the usages of the home appliances based on a user's position, and a method thereof

2. Description of the Related Art

Electronic equipment applied at home, abbreviated as home appliances, is a kind of equipment driven by electrical energy to perform family chores, such as food cooking, food reservation or cleaning. Apart from the house environment, the home appliances can also be applied in company office or industry environment.

With development of network, a new type of home appliance is available in market, such as a smart appliance. The smart appliance is usually defined as home equipment capable of monitoring and controlling its usage and protecting itself upon a consumer's requirement. The monitoring and protecting information of the smart appliance can be provided to the consumer by network technology and service. Therefore, the home appliance having a networking or interconnecting function is categorized as the smart appliance.

However, currently the user cannot know the usage of the conventional home appliance or the smart appliance instantly, and the user must actively check whether each of the home appliances is in normal functioning, individually. It is very difficult for busy modem people to make time for checking the home appliances.

In conclusion, the problem that user must individually check whether the home appliances are in normal functioning, has existed in the conventional technology for a long time, and what is need is an improved technology to solve the problem.

### SUMMARY OF THE INVENTION

In order to solve the problem that the user must individually check whether the home appliances are in normal functioning, the present disclosure illustrates a system of displaying the usages of the home appliances based on the user's position and a method thereof.

According to one exemplary embodiment of the present disclosure, the system includes a home appliance positioning module, a data collection module, a position determination module, a home appliance selection module and a home appliance control module. The home appliance positioning module is configured to detect corresponding relationships between home appliances and sockets plugged with the home appliances, to determine positions of the home appliances based on the corresponding relationships. The data collection module is configured to collect usages of the home appliances. The position determination module is configured to determine the user's current position based on the usages of the home appliances. The home appliance selection module is configured to select one of the home appliances based on the user's current position, and the selected home appliance has a display function. The home appliance control module is configured to control the selected home appliance to display the usages of the home appliances.

According to one exemplary embodiment of the present disclosure, the method includes following steps: collecting corresponding relationships between the home appliances and sockets plugged with the home appliances, and determining positions of the home appliances based on the corresponding relationships; collecting the usages of the home appliances; determining the user's current position based on the usages of the home appliances; based on the user's current position, selecting one home appliance having a display function, from the home appliances; and controlling the selected home appliance to display the usages of the home appliances.

In conclusion, the difference between the present disclosure and the conventional technology is that in the present disclosure the positions of the home appliances are determined and the usages of all home appliances are collected first, and the user's current position is determined based on the usages and positions of all home appliance, and one home appliance is selected based on the user's current position and the selected home appliance is controlled to display the usages of all home appliances, so that the present disclosure can solve the problem that user must individually check whether the home appliances are in normal functioning in the conventional technology, and achieve the technical effect that the user can check whether each of the home appliances is in normal functioning, anytime and anywhere.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a schematic view of a system of displaying usages of home appliances based on a user's position, in accordance with the present disclosure.

FIG. 2A is a flow chart of a method of displaying usages of home appliances based on a user's position, in accordance with the present disclosure.

FIG. 2B is a flow chart of optional steps of the method of displaying the usages of the home appliances based on the user's position, in accordance with the present disclosure.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

Smart appliance can be directly interconnected with a network device which can control the smart appliance, and the network device may include a mobile phone, a notebook computer and a tablet computer and so on, for example. Alternatively, the smart appliance can also be connected with the smart gateway by wired or wireless communication technology, such as Ethernet, Wi-Fi or Bluetooth, and then indirectly connected with the network device through the smart gateway. The network device can control the smart appliance. By interconnection between the smart gateway and the internet, the user can operate the network device to connect the smart gateway through the internet while not at home, so as to control the smart appliance connected with the smart gateway, or transmit a control instruction to the smart gateway to make the smart gateway control the corresponding smart appliance.

In the present disclosure, the smart gateway can determine the user's current position based on the usages of the home appliances, and control one of the home appliances to display the usages of all home appliances based on the user's current position. Moreover, when the home appliance has an abnormal usage, the smart gateway can control the home appliance which is selected to display the usages of all home appliances, to express the home appliance having the abnormal usage.

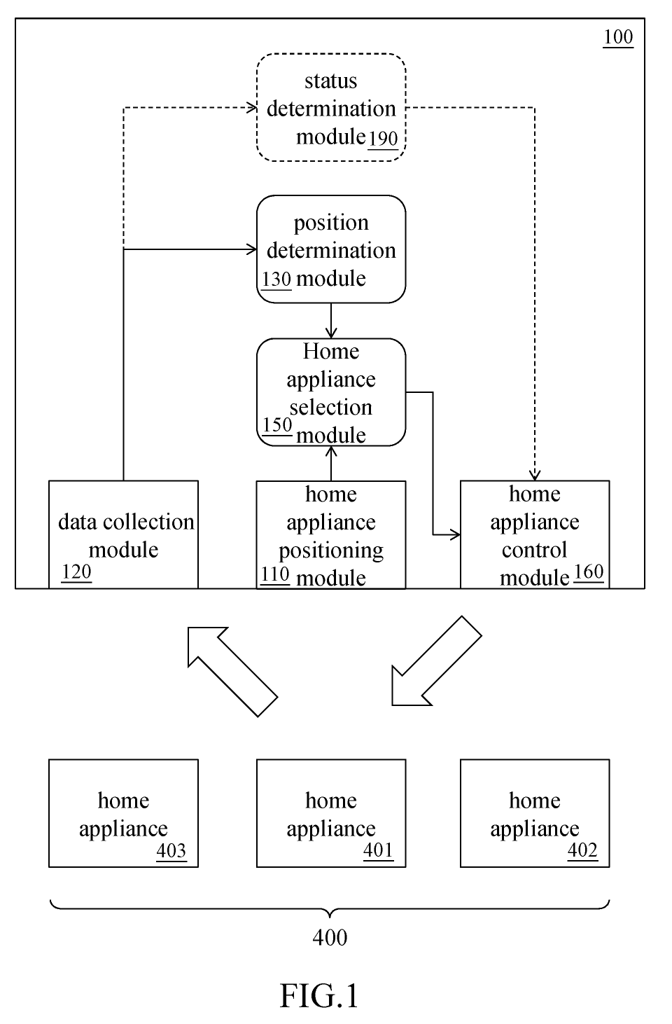

Please refer to FIG. 1 which shows a schematic view of a system of displaying usages of home appliances based on a user's position, in accordance with the present disclosure. Operation of the present disclosure is illustrated below. Please refer to FIG. 1. The system of the present disclosure (such as a smart gateway 100) includes a home appliance positioning module 110, a data collection module 120, a position determination module 130, a home appliance selection module 150, a home appliance control module 160 and a status determination module 190. In other embodiment, the status determination module 190 is optional.

The home appliance positioning module is configured to collect a corresponding relationship between at least one home appliance 400 connected with the smart gateway 100 and a socket connected with the at least one home appliance 400, and determine a position of the at least one home appliance 400 based on the collected corresponding relationship between the home appliance 400 and the socket. The home appliance positioning module 110 is configured to provide a setting interface, and the user can operate a network device (not shown in FIG. 1) to connect with the smart gateway 100 through the network, and then activate the setting interface to set the corresponding relationships between the home appliances 400 and the sockets and/or the positions of the home appliances 400. In some embodiments, the home appliance positioning module 110 can also detect the corresponding relationships between the smart appliances 400 and the sockets plugged with the smart appliances 400, for example, the home appliance positioning module 110 can detect the smart appliances respectively plugged with the smart sockets, and determine the positions of the smart appliances based on predefined positions of the smart sockets. However, the way used by the home appliance positioning module 110 to collect the corresponding relationship between the home appliance and the socket and determine the position of the home appliance is not limited to aforesaid embodiment.

The data collection module 120 is configured to collect the usages of the home appliances 400. The data collection module 120 can collect data about whether home appliance 400 is standby, power-off, or operating. In some embodiments, the data collection module 120 can also collect the operating mode or status of the home appliance 400, for example, the air conditioner being in cooling mode or dry mode, the temperature of an oven, the water heater being in heating or heat preservation; however, the present disclosure is not limited thereto.

The position determination module 130 is configured to determine the user's current position based on the usage of the at least one home appliance 400 connected with the smart gateway 100. For example, when the data collection module 120 collects the data indicating a door of a refrigerator is opened, the position determination module 130 can determine the user's current position to be the front of the refrigerator; or, when a lamp and the television in the living room are turned on, the position determination module 130 can determine the user's current position to be in the living room. However, the way used by the position determination module 130 to determine the user's current position is not limited thereto.

In some embodiments, the position determination module 130 can continuously determine the user's current position based on the usage of the one or more home appliance 400 connected with the smart gateway 10, and further determine whether the user's current position is changed.

The home appliance selection module 150 is configured to select one of all home appliances 400 connected with the smart gateway 100 based on the user's current position determined by the position determination module 130, and the home appliance 401 selected by the home appliance selection module 150 must be capable of displaying character, such as a television or a computer having a screen, or the home appliance having a LED displayer; however, the present disclosure is not limited thereto.

The home appliance selection module 150 can continuously select the home appliance 402 from all home appliances 400 connected with the smart gateway 100 based on the user's current position. In other words, when the user's current position is changed, the home appliance selection module 150 reselects the home appliance 402 from all home appliances 400 connected with the smart gateway 100 based on the user's new current position. It is worth noting that the reselected home appliance 402 may be the same as the selected home appliance 401 based on the user's previous position, for example, the user's current position is just changed slightly, or the user at the new position can still watch the home appliance 401 selected based on the previous position; however, the present disclosure is not limited thereto.

The home appliance control module 160 is configured to control the home appliance 401 selected by the home appliance selection module 150 to display the usages of all home appliances 400 connected with the smart gateway 100. Generally speaking, the home appliance control module 160 can directly transmit the usages of all home appliances 400 collected by the data collection module 120, to the home appliance 401 selected by the home appliance selection module 150 for display; however, the way used by the home appliance control module 160 to control the home appliance 401 to display the usage of the home appliances 400 is not limited thereto.

The home appliance control module 160 can control the home appliance 401 selected by the home appliance selection module 150 to display the positions of all home appliance 400 connected with the smart gateway 100. Similarly, the home appliance control module 160 can directly transmit descriptions related to the positions of all home appliances 400 determined by the home appliance positioning module 110, to the home appliances 401 selected by the home appliance selection module 150 for display.

The home appliance control module 160 can also continuously control the home appliance 401 selected by the home appliance selection module 150 to display the usages of all home appliances 400 connected with the smart gateway 100. In other words, even if the user's current position is changed and the home appliance selection module 150 reselects different home appliance 402, the home appliance control module 160 can control the home appliance 402 reselected by the home appliance selection module 150 to display the usages of all home appliances.

It is worth noting that the home appliance control module 160 can also collect a current status of the selected home appliance 401 when the home appliance selection module 150 selects the home appliance 401. When the home appliance selection module 150 reselects other home appliance 402 because of change of the user's current position, the home appliance control module 160 controls the home appliance 401 previously selected by the home appliance selection module 150 to the former status prior to the status of displaying the usages of all home appliances 400. For example, the home appliance 401 is at a standby mode when the home appliance selection module 150 selects the home appliance 401, the home appliance control module 160 can control the home appliance 401 selected by the home appliance selection module 150 to change from the standby mode to an operating mode and turn on its screen to display the usages of the home appliances 400. If the home appliance selection module 150 reselects other home appliance 402 afterwards, the home appliance control module 160 can control the home appliance 401 previously selected by the home appliance selection module 150 to turn off the screen and restore to the former status which the home appliance control module 160 collects previously, that is, the home appliance 401 is controlled to enter into the standby mode.

When the status determination module 190 determines that at least one home appliance 400 is abnormal, the home appliance control module 160 can further control the home appliance 401 selected by the home appliance selection module 150 to indicate the abnormal home appliance 403 determined by the status determination module 190. For example, the selected home appliance 401 can be controlled to display the abnormal home appliance 403 by different foreground or background color, or an extra message describing the abnormal home appliance 403, and so on. The selected home appliance 401 can also be controlled to generate an alarm sound. However, the way used by the home appliance control module 160 to control the home appliance 401 to indicate the abnormal home appliance 403 is not limited to aforesaid embodiments.

The status determination module 190 is configured to determine whether each of all home appliances 400 is abnormal, based on the usages of all home appliances 400 collected by the data collection module 120. For example, when an operating current of the home appliance is higher than the maximal current defined for a normal operation of the home appliance, the status determination module 190 can determine this home appliance to be abnormal.

The status determination module 190 can also determine whether each of all home appliances 400 is abnormal, based on the usages of the home appliances collected by the data collection module 120, and the previous usages of the home appliances 400 collected by the data collection module 120 (such previous usages are called as usage histories in the present disclosure). For example, when the home appliance is being operated for a long-term period but the usage history of the home appliance indicates no long-term operation of the home appliance existing in past, the status determination module 190 can determine the home appliance to be abnormal. Or, when the usage histories record that several home appliances are usually operated at the same time but these home appliances are not operated together now, the status determination module 190 can determine these home appliances not operated together or the home appliance being operated alone to be abnormal. However, the way used by the status determination module 190 to determine abnormality of the home appliance is not limited to aforesaid embodiment.

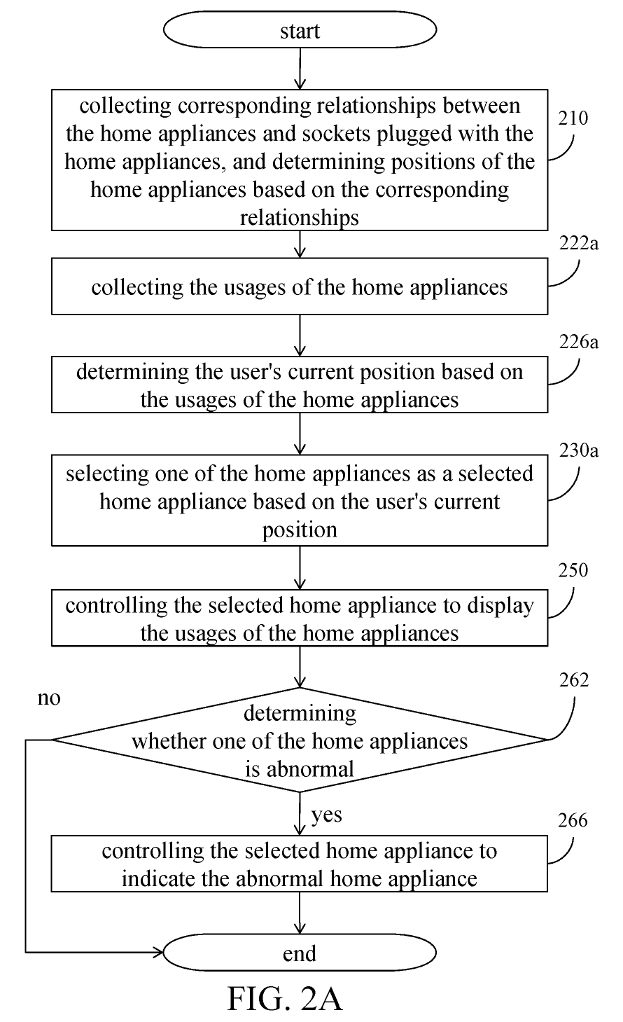

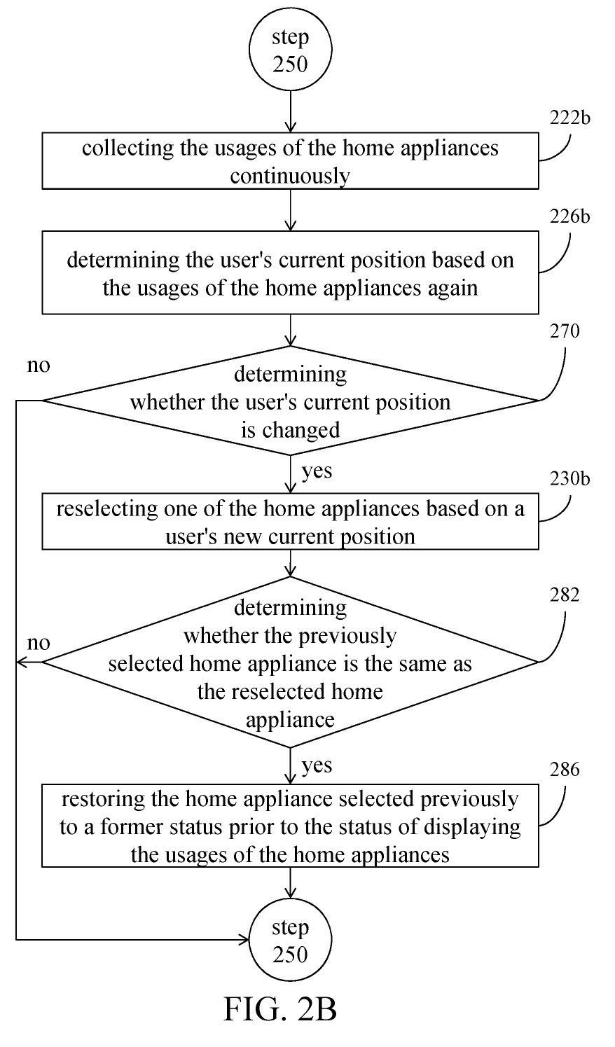

Next, an embodiment is taken as an example to illustrate the operation system and method of the present disclosure. Please refer to FIG. 2A which displays a flow chart of the method of displaying the usages of the home appliances based on the user's position, in accordance with the present disclosure.

After the user sets up the smart gateway 100, the smart gateway 100 is interconnected with all home appliances 400 through wired or wireless network.

Next, the home appliance positioning module 110 of the smart gateway 100 can collect the corresponding relationship between each home appliance 400 and the socket plugged with the home appliance 400, so as to determine the positions of all home appliances 400 based on the collected corresponding relationships (step 210). In present embodiment, it is assumed that the sockets plugged with the home appliances 400 are smart sockets, so that through the smart sockets the home appliance positioning module 110 can detect any home appliance 400 plugged with the smart sockets, and collect the data of the home appliance 400 plugged with the smart sockets, and then determine the positions of the home appliances 400 based on predefined position data.

Similarly, after the smart gateway 100 is interconnected with the home appliances 400, the data collection module 120 of the smart gateway 100 starts to collect the usages of the home appliances 400 (step 222a), and the position determination module 130 of the smart gateway 100 can determine the user's current position based on the usages of the home appliances 400 collected by the data collection module 120 (step 226a). In present embodiment, when the usage of the kitchen ventilator collected by the data collection module 120 is “in operating”, the position determination module 130 can determine that the user is in the kitchen based on the usage of the kitchen ventilator collected by the data collection module 120.

After the position determination module 130 of the smart gateway 100 determines the user's current position, the home appliance selection module 150 of the smart gateway 100 can select a home appliance 401 from all home appliances 400 based on the user's current position determined by the position determination module 130 (step 230a). The selected home appliance 401 must be capable of displaying. In present embodiment, it is assumed that the home appliance selection module 150 selects a water oven which is plugged with the socket in the kitchen and has a LED displayer.

After the home appliance selection module 150 of the smart gateway 100 selects the home appliance 401, the home appliance control module 160 of the smart gateway 100 controls the home appliance 401 selected by the home appliance selection module 150 to display the usages of all home appliances 400 (step 250). For example, in present embodiment, the home appliance control module 160 can control the selected water oven to turn on the

LED displayer to display messages indicating that the lamp in the kitchen is on, the kitchen ventilator is operating and the water oven is standby, on the LED displayer.

Therefore, by means of the technology of the present disclosure, the user can confirm the usages of all home appliances 400 anytime and anywhere at home, thereby determining whether all home appliances 400 are in normal functioning.

In addition, in aforesaid embodiment, under a condition that the smart gateway 100 includes the status determination module 190, after the data collection module 120 of the smart gateway 100 collects the usages of the home appliances 400 (step 222a), the status determination module 190 can determine whether there is an abnormal home appliance in all home appliances 400 is abnormal, based on the usages of all home appliances 400 collected by the data collection module 120 (step 262). For example, in present embodiment, the usages of all home appliances collected by the data collection module 120 include a usage that the door of the refrigerator is kept opening, the status determination module 190 can determine the refrigerator to be abnormal.

Next, the home appliance control module 160 of the smart gateway 100 can control the home appliance 401 selected by the home appliance selection module 150 to display the usages of all home appliances 400 (step 250), and further control the selected home appliance 401 to indicate the abnormal home appliance 403 (step 266). In present embodiment, it is assumed that the home appliance control module 160 can control the LED displayer of the selected water oven to display the usage of the refrigerator by different color, and particularly display a graph or symbol indicating the abnormality of the refrigerator.

In addition, the present embodiment can further include the flows shown in FIG. 2B. After the home appliance control module 160 of the smart gateway 100 controls the selected home appliance 401 to display the usage of all home appliances 400 (step 250), the data collection module 120 of the smart gateway 100 can collect the usages of the home appliances 400 continuously (step 222b), and the position determination module 130 of the smart gateway 100 again determines the user's current position based on the latest usages of all home appliances 400 collected by the data collection module 120 (step 226b), and determine whether the user's current position is changed (step 270).

If the user's current position is not changed, the home appliance control module 160 of the smart gateway 100 continues to control the same home appliance 401 to display the usages of all home appliances 400 (step 250); if the user's current position is changed, the home appliance selection module 150 of the smart gateway 100 again selects one of all home appliances 400 as the home appliance 402 based on the user's current position determined by the position determination module 130 (step 230b), and determine whether the home appliance 401 selected previously and the home appliance 402 reselected are the same (step 282).

When the home appliance 401 selected previously and the home appliance 402 selected later are the same, the home appliance control module 160 of the smart gateway 100 keeps controlling the home appliance 401 (402) to display the usages of all home appliances 400 (step step). When the home appliance 401 selected previously is different from the home appliance 402 selected later, for example, the position determination module 130 of the smart gateway 100 determines that the user moves from the kitchen to the living room and the home appliance selection module 150 of the smart gateway 100 then selects the television plugged with the socket in the living room, the home appliance control module 160 can restore the home appliance 401 selected previously to the former status prior to the status of displaying the usages of all home appliances 400 (for example, the home appliance control module 160 controls the water oven to turn off the LED displayer), and then control the reselected home appliance 402 to display the usages of all home appliances 400 (step 250).

In conclusion, the difference between the present disclosure and the conventional technology is that in the present disclosure the positions of the home appliances are determined and the usages of all home appliances are collected first, and the user's current position is determined based on the usages and positions of all home appliance, and based on the user's current position one of the home appliances is selected and controlled to display the usages of all home appliances, so that the present disclosure can solve the problem that user must individually check whether the home appliances are in normal functioning in the conventional technology, and achieve the technical effect that the user can check whether the home appliances are in normal functioning, anytime and anywhere.

Moreover, the method of controlling one home appliance to display the usages of all home appliances based on the user's position can be implemented by hardware, software or a combination thereof, or a centralization manner in a computer system, or a distributive manner where different devices are distributed in different computer systems interconnected with each other.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A method of displaying usages of home appliances based on a user's position, applicable to a smart gateway, and the method comprising steps:
collecting corresponding relationships between the home appliances and sockets plugged with the home appliances, and determining positions of the home appliances based on the corresponding relationships;
collecting the usages of the home appliances;
determining the user's current position based on the usages of the home appliances;
selecting one of the home appliances as a selected home appliance based on the user's current position, wherein the selected home appliance has a display function; and
controlling the selected home appliance to display the usages of the home appliances.

2. The method according to claim 1, the step of controlling the selected home appliance to display the usages of the home appliances further comprising:
controlling the selected home appliance to display the positions of the home appliances.

3. The method according to claim 1, further comprising:
when one of the home appliances is determined to be abnormal based on the usages of the home appliances or both usage histories and usages of the home appliances, controlling the selected home appliance to indicate the home appliance which is determined to be abnormal.

4. The method according to claim 1, further comprising:
determining the user's current position based on the usages of the home appliances continuously, and when the user's current position is changed, reselecting one of the home appliances as a reselected home appliance based on a user's new current position and controlling the reselected home appliance to display the usages of the home appliances.

5. The method according to claim 4, after the step of reselecting one of the home appliances based on the user's new current position, further comprising:
restoring the home appliance selected previously to a former status prior to the status of displaying the usages of the home appliances when the previously selected home appliance is different from the reselected home appliance.

6. A system of displaying usages of home appliances based on a user's position, comprising a home appliance positioning module configured to detect corresponding relationships between the home appliances and sockets plugged with the home appliances, to determine positions of the home appliances based on the corresponding relationships;
a data collection module configured to collect the usages of the home appliances;
a position determination module configured to determine the user's current position based on the usages of the home appliances;
a home appliance selection module configured to select one of the home appliances as a selected home appliance based on the user's current position, wherein the selected home appliance has a display function; and
a home appliance control module configured to control the select home appliance to display the usages of the home appliances.

7. The system according to claim 6, wherein the home appliance control module further controls the selected home appliance to display the positions of the home appliances.

8. The system according to claim 6, further comprising a status determination module configured to determine whether there is an abnormal home appliance in the home appliance, based on the usages of the home appliances or both usage histories and usages of the home appliances collected by the data collection module, and wherein when the status determination module determines that there is the abnormal home appliance in the home appliances, the home appliance control module is configured to control the selected home appliance to indicate the abnormal home appliance.

9. The system according to claim 6, wherein the position determination module further configured to determine the user's current position based on the usages of the home appliances continuously, and determine whether the user's current position is changed, wherein when the position determination module determines that the user's current position is changed, the home appliance selection module reselects one of the home appliances as a reselected home appliance based on a user's new current position and the home appliance control module controls the reselected home appliance to display the usages of the home appliances.

10. The system according to claim 9, wherein the home appliance control module further restores the selected home appliance to a former status prior to the status of displaying the usages of the home appliances when the previously selected home appliance is different from the reselected home appliance.
